(19) United States
(12) Patent Application Publication
(10) Pub. No.: US 2008/0055551 A1
(43) Pub. Date: Mar. 6, 2008

(54) Optical Element, Method of Manufacturing the Same, and Projector

(75) Inventors: Takashi ENDO, Shiojiri-shi (JP); Toshiaki HASHIZUME, Okaya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/843,900

(22) Filed: Aug. 23, 2007

(30) Foreign Application Priority Data
Aug. 31, 2006 (JP) 2006-235146
Jun. 20, 2007 (JP) 2007-162297

(51) Int. Cl. G03B 21/14; B29D 11/00; G02F 1/13

(52) U.S. Cl. 353/20; 264/1.38; 264/1.7; 349/193; 353/38

(57) ABSTRACT

An optical element includes a first substrate, a second substrate, a retardation plate made of an inorganic material, having refractive index anisotropy, and having a thin plate like main part to be disposed between the first substrate and the second substrate, the main part being formed to be thin in comparison with a thickness of the first substrate and a thickness of the second substrate, a first adhesive layer for filling a gap between the first substrate and the retardation plate, and a second adhesive layer for filling a gap between the retardation plate and the second substrate.

### BACKGROUND

1. Technical Field

The present invention relates to an optical, element used as a retardation element and so on and a method of manufacturing the optical element, and further to a projector incorporating the optical element.

2. Related Art

As past projectors, there have been projectors forming image light by controlling transmitted light with liquid crystal light valves each provided with a pair of polarization plates disposed in front of and behind a liquid crystal panel. Further, in such projectors, there exists a projector that compensates the phase shift generated by birefringence caused by the pretilt remaining in the liquid crystal by, for example, disposing a compensating retardation element between the liquid crystal panel and the incident side polarization plate, thus improving the contrast (see JP-A-10-312166).

Such a retardation element as described above is made of a birefringent material such as sapphire or quartz, and in some cases, a very thin film-like plate member made of such a birefringent material is fixed with an adhesive on a thick supporting transparent substrate made, for example, of glass. In such a case, since the film-like plate member made of quartz or the like is pressed against the thick substrate in the periphery thereof, a phenomenon nave been caused that the center portion of the film-like plate member is deformed to rise with the adhesive and the surface of the film-like plate member forms a shape of a slightly convex lens. Further, in the case of using an etching process for thin film forming process, fine irregularity like scales may appear on the surface of the birefringent material. If such a film-like plate member, namely a retardation element, having a surface like a convex lens or a surface with fine irregularity is incorporated in a projector, there are caused problems that the projected image is distorted, and includes a defocussed portion.

### SUMMARY

An advantage of some aspects of the invention is to provide an optical element such as a retardation element with high accuracy provided with a thin film-like birefringent material bonded therewith, and a manufacturing method thereof.

Another advantage of some aspects of the invention is to provide a projector capable of projecting an image with high accuracy by incorporating the optical element as described above.

An optical element according to an aspect of the invention includes a first substrate, a second substrate, a retardation plate made of an inorganic material, having refractive index anisotropy, and having a thin plate like main part to be disposed between the first substrate and the second substrate, the main part being formed to be thin in comparison with a thickness of the first substrate and a thickness of the second substrate, a first adhesive layer for filling a gap between the first substrate and the retardation plate, and a second adhesive layer for filling a gap between the retardation plate and the second substrate.

Since the optical element described above has a unique sandwich structure of holding the relatively thin main part having refractive index anisotropy between the relatively thick first and second substrates via the adhesive layers, even in the case in which the relatively thin retardation plate is distorted and deformed in manufacturing the optical element or fine irregularity exists on the surface, such an undesired shape of the main part can be repaired by the first and the second adhesive layers. More specifically, for example, when the retardation plate is fixed to the first substrate, the center of the thin plate like main part has a rise by the first adhesive layer, when the second substrate is fixed to the retardation plate, such a rise can be repaired by the second adhesive layer to cancel out such a deformation. It should be noted that the first and the second substrates are made thicker than the retardation plate, and accordingly relatively hard to be distorted, and it is possible to obtain the shape of the optical element which can hardly be distorted or deformed as a whole, and the optical element with sufficiently high strength can be obtained. As described above, according to the present optical element, since chances of unexpected operations of collection or diffusion in transmission through the retardation plate can be reduced, the optical characteristic of the optical element can be made more precise, and if the optical element is incorporated in the projector, image projection with high accuracy becomes possible.

Further, according to the specific aspect or a view point of the invention, in the optical element described above, the refractive index of the first adhesive layer is substantially the same as the refractive index of the second adhesive layer. In this case, the distortion and deformation of the retardation plate can be compensated by the convex shape of the first adhesive layer on the one hand and the concave shape of the second adhesive layer on the other hand, thus the both sides of the distorted retardation elate can be filled with the material with the same refractive index, accordingly, as long as the first and the second substrates are planar, it can be possible that the any lens-like effects namely positive or negative refractive force by the optical element can be eliminated. Further, in the case in which fine irregularity exists on the surface of the optical element, since the irregularity can be filled with the adhesive, it can be prevented that the light is scattered or refracted by the fine irregularity.

According to another aspect of the invention, it is preferable that the refractive index of the retardation plate is substantially the same as the refractive index of the first and second adhesive layers. In this case, reflection on the surface of the retardation plate can be suppressed, thus the optical characteristic of the optical element can be improved to be further accurate.

According to still another aspect of the invention, the thin plate like main part of the retardation plate provides retardation, and the retardation plate have a thicker portion having a thickness larger than the main part in at least a part of a surrounding area of the main part. In this case, the strength of the retardation plate as a whole can be enhanced by the thicker portion to make the handling of the retardation plate easier, and at the same time, in fixing the retardation plate to the first substrate, it becomes easy to press the retardation plate against the first substrate, thus enhancing the workability of the manufacturing process.

According to still another aspect of the invention, the retardation plate is made of quartz, and the first and the second substrates are made of one of quartz, sapphire, and glass. In this case, quartz is low in hardness in comparison with the sapphire, and accordingly easy to be distorted, but as described above, by holding the retardation plate on both sides with the first and the second substrates with higher hardness via the first and the second adhesive layers, the function such as collection of light can be prevented from occurring.

According to still another aspect of the invention, the first and the second adhesive layers are made of light curing resin. In this case, the operation of holding the retardation plate between the first and the second substrates and fixing it become easy, and the optical element with high accuracy can be provided in a simple manufacturing process.

The projector according to an aspect of the invention, is for projecting the image light formed in the optical modulation device illuminated by the illuminating device with the projection lens, and is equipped with the optical element of the above aspect of the invention. In this case, optical compensation of the liquid crystal panel of the optical modulation device can be improved, thus the high quality image can be projected.

According to the specific aspect of the projector, the optical modulation device includes a transmissive liquid crystal panel, and a pair of polarization elements disposed on both sides of the transmissive liquid crystal panel, the optical element is disposed between at least one of the polarization elements and the transmissive liquid crystal panel In this case, the optical device functions as, for example, an optical compensation plate and so on.

According to another aspect of the projector, the optical modulation device includes a reflective liquid crystal panel, a polarizing beam splitter provided corresponding to the reflective liquid crystal panel, and the optical element is disposed between the polarizing beam splitter and the reflective liquid crystal panel. In this case, the optical device functions as, for example, an optical compensation plate and so on.

According to another aspect of the invention, there is provided a method of manufacturing an optical element including the steps of (a) forming a retardation plate having a main part with a thickness providing predetermined retardation by etching a planar member made of an inorganic material and having refractive index anisotropy, (b) pressing a periphery of the retardation plate against a first substrate formed to be thick in comparison with the thickness of the main part of the retardation plate, after the retardation plate is mounted on the first substrate via the first adhesive layer, and (c) pressing the second substrate against the retardation plate after mounting the second substrate formed to be thick in comparison with the thickness of the main part of the retardation plate via a second adhesive layer.

According to the above manufacturing method, since the retardation plate is mounted on the first substrate via the first adhesive layer, and the retardation plate is pressed against the first substrate, and the second substrate is mounted on the retardation plate via the second adhesive layer, and pressed against the retardation plate, if the center of the thin plate like main part of the retardation plate rises due to the presence of the first adhesive layer when the retardation plate is fixed to the first substrate, such a rise can be canceled out to some extent by the second adhesive layer when the second substrate is fixed. Therefore, according to the present optical element thus obtained, since chances of unexpected operations of collection and so on in transmission through the retardation plate can be reduced, the optical characteristic of the optical element can be made more precise, and if the optical element is incorporated in the projector, image projection with high accuracy becomes possible.

Further, according to a specific aspect or a view point of the invention, in the manufacturing method described above, the step of etching the planar member includes masking the all of the surfaces of the planar member except a center portion of the one side of the retardation plate, the center portion corresponding to the main part, and dipping the planar member after masking in an etchant for wet etching. In this case, by processing with the wet etching, the the center portion as the main part namely the thin film like shape for generating the birefringence property can be formed simply and with high accuracy.

According to another aspect of the invention, curing the first adhesive layer with ultraviolet irradiation after pressing the retardation plate against the first substrate via the first adhesive layer, and curing the second adhesive layer with ultraviolet irradiation after pressing the second substrate against the retardation plate via the second adhesive layer. In this case, the operation of holding the retardation plate between the first and the second substrates and fixing it become easy, and the optical element with high accuracy can be provided in a simple manufacturing process.

### BRIEF DESCRIPTION OF THE DRAWINGS

The invention will now be described with reference to the accompanying drawings, wherein like numbers refer to like elements.

FIGS. 1A and 1B are side sectional view and plan view, respectively, of a retardation element according to a first embodiment.

FIGS. 2A through 2F are side sectional views for explaining a manufacturing process of the retardation element shown in FIGS. 1A and 1B.

FIG. 3 is a perspective view for explaining a shape of the retardation plate shown in the step of FIG. 2B.

FIG. 4 is a diagram for explaining an optical system of a projector according to a second embodiment incorporating the retardation element shown in FIGS. 1A and 1B.

FIGS. 5A through 5C are pictures showing imaging conditions with the retardation element according to the embodiment incorporated therein.

FIGS. 6A through 6C are pictures showing imaging conditions with the retardation element according to a comparative example incorporated therein.

FIG. 7 is a diagram for explaining an optical system of a projector according to a third embodiment incorporating the retardation element shown in FIGS. 1A and 1B.

### DESCRIPTION OF EXEMPLARY EMBODIMENTS

### First Embodiment

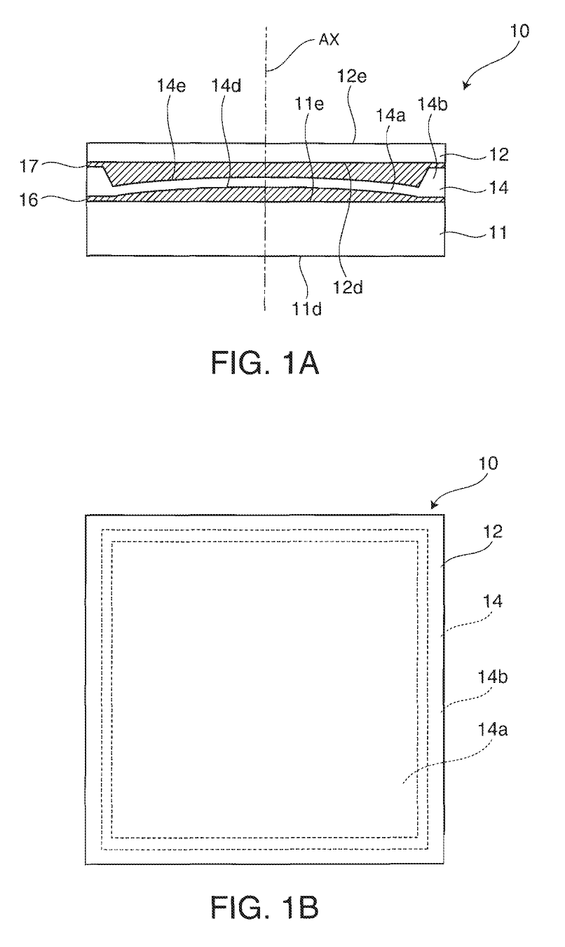

FIGS. 1A and 1B are side sectional view and plan view, respectively, for conceptually explaining the structure of the retardation element as the optical element of the first embodiment according to the invention.

The retardation element 10 show in the drawings has a sandwich structure with stacked layers, and is provided with a planar first substrate 11, a planar second substrate 12, and a retardation plate 14 held between the both substrates 11, 12. Between the first substrate 11 and the retardation plate 14, there is provided a first adhesive layer 16 so as to fill the gap between the two components, and the first substrate 11 and the retardation plate 14 are fixed to each other with the first adhesive layer 16. Between the second substrate 12 and the retardation plate 14, there is provided a second adhesive layer 17 so as to fill the gap between the two components, and the second substrate 12 and the retardation plate 14 are fixed to each other with the second adhesive layer 17.

The first substrate 11 is a relatively thick planar member made of an inorganic material such as glass, sapphire or quartz, and a surface 11d to be, for example, an incident side and a surface 11e to be, for example, an exit side of the first substrate 11 are substantially parallel to each other. The first substrate 11 has a light transmission property with respect to visible light and so on, but does not have a lens function such as collection of light. On the other hand, the second substrate 12 is also a relatively thick planar member made of an inorganic material such as glass, sapphire or quartz, and a surface 12d to be, for example, an incident side and a surface 12e to be, for example, an exit side of the second substrate 12 are also substantially parallel to each other. Further, the second substrate 12 has a light transmission property with respect to visible light and so on, but does not have a lens function such as collection of light. It should be noted that the both substrates 11, 12 are each formed to have a relatively large thickness of about several hundreds of micrometers through several millimeters, and form supporting members hardly deformed by deflection caused by stress in the manufacturing or assembling process.

The retardation plate 14 is a thin planar member as a whole made of an inorganic material such as quartz or sapphire, and is provided with a main part 14a having a rectangular thin plate like shape, and a pressing rim section 14b as a thicker part of the retardation plate 14 disposed surrounding the periphery of the main part 14a.

Here, the main part 14a is made, for example, of a refractive index anisotropic material such as a positive uniaxial crystal having a direction of the crystal axis namely a direction (direction of the coordination) of the optical axis aligned, for example, with the light axis AX or an arbitrary direction in a plane perpendicular to the light axis AX, and has a thickness of about several micrometers through ten-odd micrometers in order for realizing the targeted retardation. Since the main part 14a has a thin film-like shape as described above, in bonding the retardation plate 14 to the first substrate 11 via the first adhesive layer 16, a rise shaped like a convex lens as small as about several tens of micrometers is formed at the center portion thereof. Therefore, the surface 14d of the main part 14a described as a lower side in the drawing should be formed as a concave surface towards the side of the first adhesive layer 16, the surface 14e described above the surface 14d in the drawing should be formed as a convex surface towards the side of the second adhesive layer 17. The pressing rim section 14b is a part thereof for pressing the retardation plate 14 against the first substrate 11, and is formed as a thicker rim part thereof to assure the mechanical strength of the retardation plate 14, thereby making the pressing operation of the retardation plate 14 reliable. In this case, a protruding direction of the pressing rim section 14b is arranged to be the direction towards the side of the second substrate 12 to be bonded later for the sake of manufacturing convenience. It should be noted however that if the pressing rim section 14b is not provided, it is required to bond the main part 14a directly with the first substrate 11, scratches, chips, or cracks are easily caused on the surface of the main part 14a.

The first adhesive layer 16 is made of light curing resin such as ultraviolet curing resin, and bonds the first substrate 11 with the retardation plate 14 to be fixed to each other. In this case, the first adhesive layer 16 is held between the both surfaces 11e and 14d to have an appearance like a convex lens. Further, the second adhesive layer 17 is also made of light curing resin, and bonds the second substrate 12 with the retardation plate 14 to be fixed to each other. In this case, the second adhesive layer 17 is held between the both surfaces 12d and 14e to have an appearance like a concave lens. It should be noted that the light curing resin such as the ultraviolet curing resin can be controlled in the refractive index in the visible wavelength band in the range of, for example, about 1.3 through 1.7, and accordingly the refractive index can be set to be substantially equal to, for example, 1.5, the refractive index of quartz which forms the first substrate 11. Therefore, the refractive power as a lens can be prevented from being caused on the curved surface 14d in the boundary between the first adhesive layer 16 and the retardation plate 14, and further the refractive power as a lens can be prevented from being caused on the curved surface 14e in the boundary between the second adhesive layer 17 and the retardation plate 14. Thus, the phenomenon can be suppressed that the light passing through the retardation element 10 having a planar shape as a whole is collected or diffused by the difference in the refractive index inside the retardation element 10. It should be noted that if there is some difference in the refractive index between the retardation plate 14 and the first and second adhesive layers 16, 17, since the concave shape and the convex shape of the both adhesive layers 16, 17 cancel out the difference from each other, the refractive force is not caused in the retardation element 10 as a whole in terms of results. However, if the difference in the refractive index between the retardation plate 14 and the first and second adhesive layers 16, 17 becomes large, reflection on the interface becomes measurable, and accordingly, it is preferable that the refractive indexes of the both layers are relatively close to each other.

It should be noted that in the case in which the retardation plate 14 is made of quartz, the amount of distortion of the main part 14a tends to be larger to cause a problem. A value called bending strength for indicating flexibility is generally used. Quartz has a bending strength of about 50 MPa, which is considerably lower than the bending strength of sapphire of about 450 through 700 MPa. Therefore, in the case in which the retardation plate 14 is made of quartz, the main part 14a is distorted with particular ease, thus, by adopting the configuration of the present embodiment, generation of the refractive force caused by the distortion of the main part 14a can efficiently be prevented.

In the retardation element 10 as described above, if the second adhesive layer 17 is not provided to fill in the space or the second substrate 12 is not bonded therewith, the retardation element should be composed of the first substrate 11, the second substrate 12, and the first adhesive layer 16. In this case, there is a probability that the surface 14e of the main part 14a thus exposed functions as a convex lens surface to cause unnecessary focusing action, thus degrading the optical characteristics.

If such a retardation element is disposed in, for example, the periphery of the liquid crystal light valve and so on of the projector, there is a possibility that defocus is caused in, the projected image in the center area or the peripheral area of the screen.

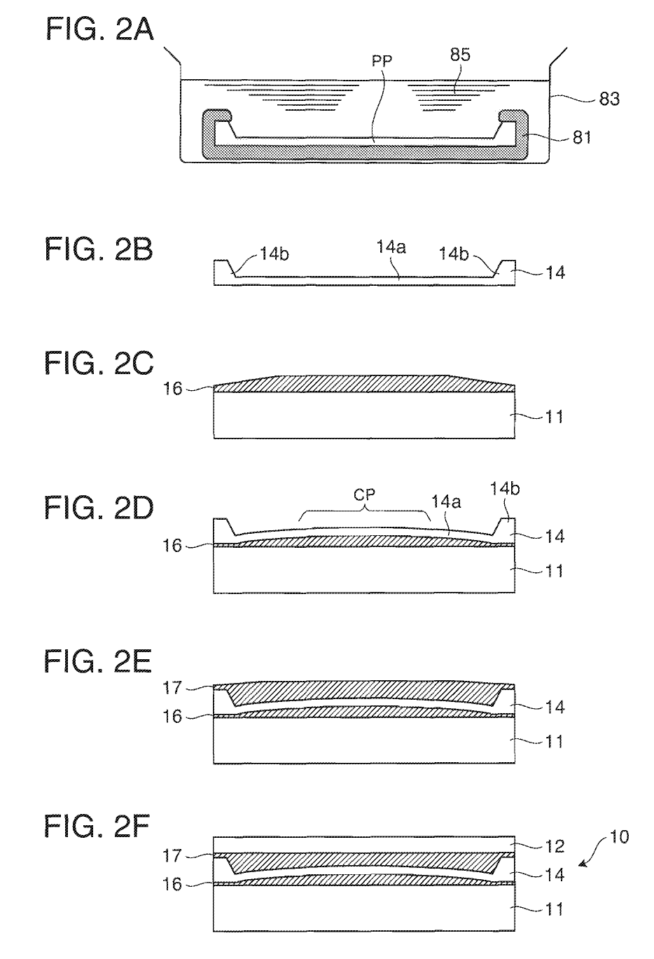

Hereinafter, a method of manufacturing the retardation element 10 shown in FIGS. 1A and 1B is explained with reference to FIGS. 2A though 2F. The materials for the first and the second substrates 11, 12 and the retardation plate 14 to be the composing elements of the retardation element 10 are prepared in advance. Specifically, planar materials such as glass, sapphire, or quartz as the materials for the first and the second substrates 11, 12, are carved out, and a process such as polishing is executed on each of the surfaces of the plates to obtain plates with targeted thicknesses (e.g., 0.5 m). Meanwhile, in parallel to this process, a planar material such as quartz as the material for the retardation plate 14 is carved out, and a process such as polishing is performed on the surface of the plate to obtain the plate with targeted thickness (e.g., 80 μm). In this case, to arrange the optical axis of the main part 14a of the retardation plate 14 to be the targeted direction and the tilt angle, the material of the retardation plate 14 is curved out so that the optical axis thereof has the disposition as targeted. It should be noted that regarding the first and the second substrates 11, 12, if the crystalline material such as sapphire or quartz is used instead of glass, the materials for the first and the second substrates 11, 12 are also curved out so that the optical axes are disposed as targeted.

Subsequently, as shown in FIG. 2A, a mask 81 is provided to the plate PP made of quartz or the like as the material of the retardation plate 14 so as to expose a rectangular area at the center of the surfaces of the one side of the plate, end then the hydrofluoric acid treatment is performed on the plate PP. The mask 81 is made, for example, of an alloy of chromium and gold, or various rubber-based organic matters. It should be noted that it is only required for the mask 81 to have corrosion resistance against the fluorinated acid as the etchant, and the material therefor is not limited to the materials described above. Then, the plate PP with the mask is dipped in the treatment container 83 filled with the hydrogen fluoride solution 85 for a predetermined period of time. Thus, the rectangular area at the center of the plate PP is etched from one side to form the center portion of the plane PP with a targeted thickness. In this case, although the exposed plane of a front side of the plate PP is curved by the etching process, the periphery of the exposed plane of the plate PP and the plane of a back side of the plate PP are protected from etching by the mask 81.

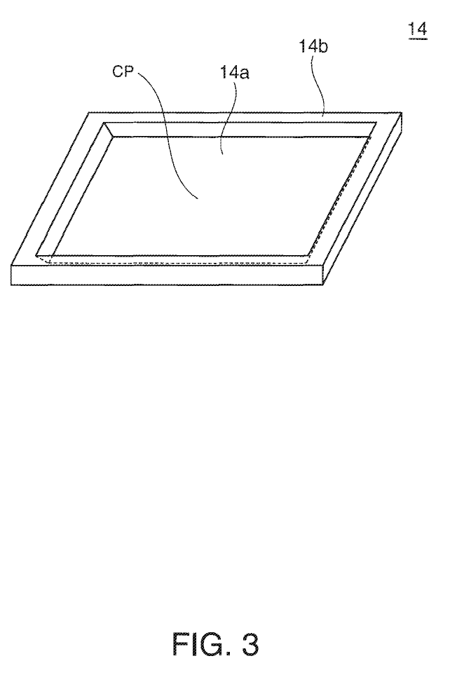

Subsequently, as shown in FIG. 2B, the plate PP processed with the fluorinated acid is taken out from the treatment container 83, an appropriate rinse process is performed on the surface thereof, and the mask 81 is removed therefrom to form the retardation plate 14 in a ready condition for the subsequent process. FIG. 3 is a perspective view of the retardation plate 14. As apparent from the drawing, the retardation plate 14 is provided with the main part 14a shaped like a thin plate and surrounded by the pressing rim section 14b in the periphery thereof, and the main part 14a has a thickness of, for example, about several micrometers through ten-odd micrometers so as to be able to provide necessary retardation. Further, the pressing rim section 14b has a thickness of slightly smaller than about a hundred micrometers through a several hundreds micrometers so as to be able to assure necessary strength.

Then, as shown in FIG. 2C, by applying and thinly spreading the ultraviolet curing resin on the first substrate 11 previously prepared, the first adhesive layer 16 shaped like a thin film is formed. Then, as shown in FIG. 2D, the retardation plate 14 is mounted on and bonded with the first substrate 11 via the first adhesive layer 16 with the recessed surface of the retardation plate 14 disposed on the upper side. After then, the first adhesive layer 16 is cured with an ultraviolet beam. Here, in the retardation plate 14, the main part 14a considerably thinner than the first substrate 11, which is so thin as to be flexible, has a rise at the center portion CP to form a convex surface as a whole. In this case, the first adhesive layer 16 becomes thicker at the center portion to form a shape like a convex lens. On the other hand, regarding the first substrate 11, since it is thicker than the main part 14a of the retardation plate 14, it is not distorted. It should be noted that the ultraviolet curing resin forming the first adhesive layer 16 can be made, for example, of epoxy resin, which has small difference in the refractive index from the retardation plate 14 or the first substrate 11.

Then, as shown in FIG. 2E, by applying and thinly spreading the ultraviolet curing resin on the retardation plate 14 in the condition shown in FIG. 2D, the second adhesive layer 17 shaped like a thin film is formed. Subsequently, as shown in FIG. 2F, the second substrate 12 is mounted and bonded thereon via the second adhesive layer 17. After then, the second adhesive layer 17 is cured with an ultraviolet beam. Thus, the retardation element 10 having a planar shape as a whole can be obtained. Here, since the second substrate 12, which is thicker than the main part 14a of the retardation plate 14, is not distorted, the second adhesive layer 17 becomes thinner at the center portion thereof under the influence of the main part 14a to form a shape like a concave lens. It should be noted that the ultraviolet curing resin forming the second adhesive layer 17 can be made, for example, of epoxy resin, which has small difference in the refractive index from the retardation plate 14 or the second substrate 12.

In terms of results, the refractive power as a lens can be prevented from being caused on the curved surface 14d in the boundary between the first adhesive layer 16 and the retardation plate 14, and further the refractive power as a lens can be prevented from being caused on the curved surface 14e in the boundary between the second adhesive layer 17 and the retardation plate 14. Further, even in the case in which the fine irregularity like scales is caused on the surfaces 14d and 14e by the etching process described above, such irregularity like scales can be repaired by the first and the second adhesive layers 16, 17, and accordingly, it can be prevented that the light is scattered or refracted by the fine irregularity in the boundary section between the first adhesive layer 16 and the surface 14d or the boundary section between the second adhesive layer 17 and the surface 14e. It should be noted that even if there is some difference in refractive index between the retardation plate 14 and the first and second adhesive layers 16, 17, since the shape of the second adhesive layer 17 is arranged to cancel out the shape of the first adhesive layer 16, the retardation element 10 as a whole does not cause the refractive force, and at the same time, the effect of providing retardation can be caused by the retardation plate 14 held therebetween. In this case, although the retardation caused by the retardation plate 14 becomes uneven in a strict sense when the main part 14a of the retardation plate 14 is distorted, the unevenness is as small as less than one degree in angle, and the influence on the contrast is not so significant.

### Second Embodiment

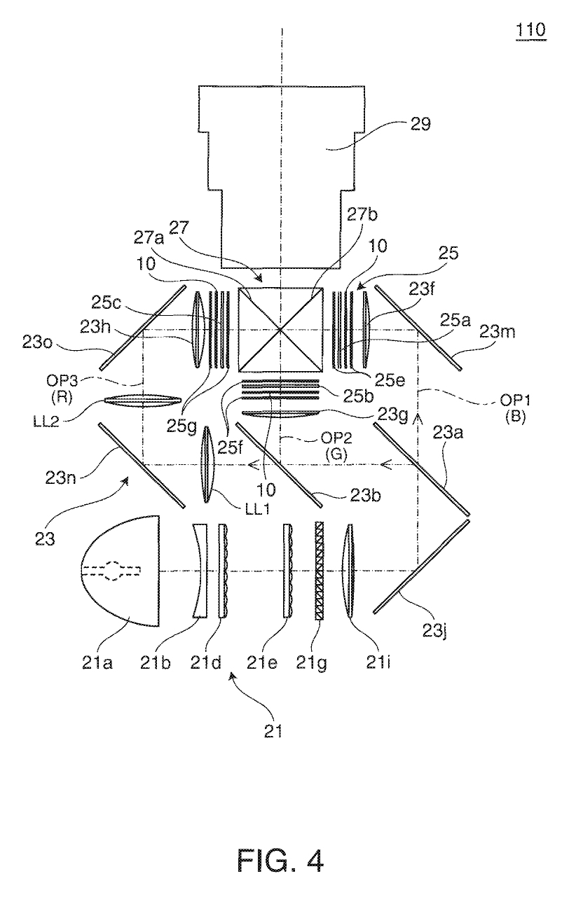

FIG. 4 is a diagram for explaining the configuration of an optical system of a projector incorporating the retardation element 10 shown in FIGS. 1A and 1B.

The present projector 110 is provided with a light source device 21 for generating source light, a color separation optical system 23 for separating the source light from the light source device 21 into three colors of light, red, green, and blue, an optical modulation section 25 illuminated by the illumination light of respective colors emitted from the color separation optical system 23, a cross dichroic prism 27 for combining the image light of respective colors from the optical modulation section 25, and a projection lens 29 as a projection optical system for projecting the image light passed through the cross dichroic prism 27 on a screen (not shown).

In the projector 110 described above, the light source 21 is provided with a light source lamp 21a, a concave lens 21b, a pair of fly-eye lenses 21d, 21e, a polarization conversion member 21g, and a superposing lens 21i. In these components, the light source lamp 21a is formed, for example, of a high pressure mercury vapor lamp, and is equipped with a concave mirror for collecting the source light to emit it forward. The concave lens 21b has a role of parallelizing the source light from the light source lamp 21a, but can also be eliminated. The pair of fly-eye lens 21d, 21e is each composed of a plurality of element lenses disposed in a matrix, and divides the source light from the light source lamp 21a passing through the concave lens 21b with these element lenses to be individually collected or diffused. The polarization conversion member 21g converts the source light emitted from the fly-eye lens 21e into, for example, the light with only the S-polarized component perpendicular to the sheet of FIG. 4, and supplies it to the subsequent optical system. The superposing lens 21i appropriately collects the illumination light passing through the polarization conversion member 21g as a whole, thereby making it possible to illuminate in a superposed manner the optical modulation devices of respective colors provided in the optical modulation section 25. Specifically, the illumination light passing through the both fly-eye lenses 21d, 21e and the superposing lens 21i evenly illuminates in a superposed manner the liquid crystal panels 25a, 25b, and 25c of respective colors disposed in the optical modulation section 25 after passing through the color separation optical system 23 described in detail below.

The color separation optical system 23 is provided with first and second dichroic mirrors 23a, 23b, three field lenses 23f, 23g, and 23h as the correction optical system, and reflection mirrors 23j, 23m, 23n, and 23o, and forms the illuminating device together with the light source device 21. Here, the first dichroic mirror 23a reflects, for example, red light and green light and transmits blue light in the three colors of light of red, green, and blue. Further, the second dichroic mirror 23b reflects, for example, the green light and transmits the red light in the two colors of light of red and green input therein. In the color separation optical system 23, the substantially white source light from the light source device 21 enters the first dichroic mirror 23a with the light path folded by the reflective mirror 23j. The blue light passing through the first dichroic mirror 23a enters the field lens 23f via the reflection mirror 23m while staying as, for example, S-polarized light. Further, the green light reflected by the first dichroic mirror 23a, and further reflected by the second dichroic mirror 23b enters the field lens 23g while staying as, for example, S-polarized light. Further, the red light passing through the second dichroic mirror 23b enters the field lens 23h for adjusting the incident angle via the lenses LL1, LL2, and the reflection mirrors 23n, 23o while staying as, for example, S-polarized light. The lenses LL1, LL2 and the field lens 23h form a relay optical system. The relay optical system has a function of almost directly transmitting the image in the first lens LL1 to the field lens 23h via the second lens LL2.

The optical modulation section 25 is provided with three liquid crystal panels 25a, 25b, and 25c, three pairs of polarization filters 25e, 25f, and 25g, disposed on the both sides of the liquid crystal panels 25a, 25b, and 25c, respectively. Here, the liquid crystal panel 25a for the blue light disposed on the first optical path OP1 and the pair of polarization filters 25e, 25e disposed on the both sides of the liquid crystal panel 25a form a liquid crystal light valve for the blue light for performing the intensity modulation on the blue light two-dimensionally in accordance with the image information. In these components, the liquid crystal panel 25a is equipped with, for example, a liquid crystal cell performing a homeotropic alignment type of operation, but can be arranged to include a liquid crystal cell performing a TN type of operation. The liquid crystal panel 25a has a typical configuration of holding the liquid crystal layer between a pair of substrates, and is provided with an oriented film, a transparent common electrode layer, a black matrix, and so on disposed on the front side substrate, and an oriented film, a transparent pixel electrode, a circuit layer, and so on disposed on the reverse side substrate. The liquid crystal light valve for the blue light incorporates the retardation element 10 shown in FIGS. 1A and 1B between, for example, the polarization filter 25e and the liquid crystal panel 25a as an optical compensation film for improving the contrast. Similarly, the liquid crystal panel 25b for the green light and the corresponding polarization filters 25f, 25f disposed on the second optical path OP2 also form the liquid crystal light valve for the green light, and the liquid crystal panel 25c for the red light and the corresponding polarization filters 25g, 25g disposed on the third optical path OP3 also form the liquid crystal light valve for the red light. Further, the liquid crystal light valves for the green light and the red light respectively incorporate the retardation elements 10 shown in FIGS. 1A and 1B between, for example, the first polarization filters 25f, 25g and the liquid crystal panels 25b, 25c as the optical compensation film for improving the contrast. It should be noted that the polarization filters 25e, 25f, and 25g can be formed as absorption type polarizers made of resin or the like, or as reflection type polarizers such as wire-grid polarizers.

The blue light branched by being transmitted through the first dichroic mirror 23a of the color separation optical system 23 enters the first liquid crystal panel 25a for the blue light via the field lens 23f. The green light branched by being reflected by the second dichroic mirror 23b of the color separation optical system 23 enters the second liquid crystal panel 25b for the green light via the field lens 23g. The red light branched by being transmitted through the second dichroic mirror 23b enters the third liquid crystal panel 25c for the red light via the field lens 23h. Each of the liquid crystal panels 25a through 25c is a passive type optical modulation device for modulating the spatial intensity distribution of the entering illumination light, and the three colors of light entering the respective liquid crystal panels 25a through 25c is modulated in accordance with the drive signals or image signals input to the respective liquid crystal panels 25a through 25c as electric signals. In this case, the polarization directions of the illumination light entering the liquid crystal panels 25a through 25c are adjusted by the polarization filters 25e, 25f, and 25g, ant the component light with predetermined polarization direction is taken out from the modulated light emitted from the respective liquid crystal panels 25a through 25c as the image light. Further, the retardation elements 10 perform adjustment so that the phase modulation by the liquid crystal panels 25a through 25c becomes appropriate, thus the optical compensation becomes possible.

The cross dichroic prism 27 is a light combining member and has a substantially rectangular planar shape formed of four rectangular prisms bonded with each other, and on the interfaces on which the rectangular prisms are bonded with each other, there are formed a pair of dielectric multilayer films 27a, 27b intersecting with each other forming an X-shape. One of the pair of dielectric multilayer films, the first dielectric multilayer film 27a, reflects the blue light while the other of the pair of dielectric multilayer films, the second dielectric multilayer film 27b, reflects the red light. The cross dichroic prism 27 reflects the blue light from the liquid crystal panel 25a with the first dielectric multilayer film 27a to emit the blue light rightward in the traveling direction, transmits the green light from the liquid crystal panel 25b to emit the green light straight through the first and second dielectric multilayer films 27a, 27b, and reflects the red light from the liquid crystal panel 25c with the second dielectric multilayer film 27b to emit the red light leftward in the traveling direction.

The projection lens 29 projects the color image light combined by the cross dichroic prism 27 on the screen (not shown) with a desired magnification. Therefore, a color movie or a color still image corresponding to the drive signals or the image signals input to the respective liquid crystal panels 25a through 25c is projected on the screen with a desired magnification.

In the projector 110 described above, the retardation elements 10 incorporated in the optical modulation section 25 are used, as already explained, for the purpose of, for example, fine-tuning the phase modulation amount which the liquid crystal panels 25a through 25c have failed to adjust accurately. By disposing such a retardation element 10 in the right place within the liquid crystal light valve, the contrast in optical modulation with the optical modulation section 25 can be enhanced, or efficient and precise control of the optical modulation amount becomes possible, thus projection of high quality images becomes possible. In this case, the direction of the optical axis nil the main part 14a and the thickness of the main part 14a of the retardation plate 14 incorporated in the diffraction phase element 10 can correspond to the adjusting amount necessary for the birefringent retardation provided by the liquid crystal panels 25a through 25c. Therefore, in the retardation element 10, the thickness of the main part 14a inside thereof becomes extremely thin in the normal condition, and such a thickness is preferably set for each of the liquid crystal panels 25a through 25c.

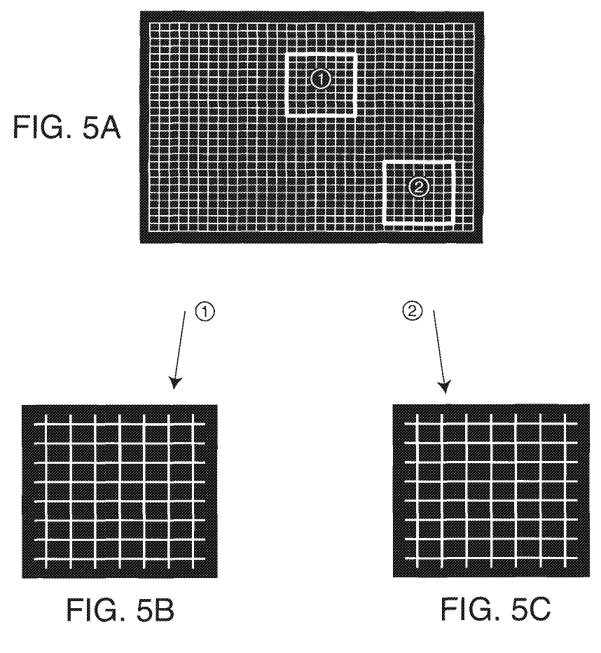

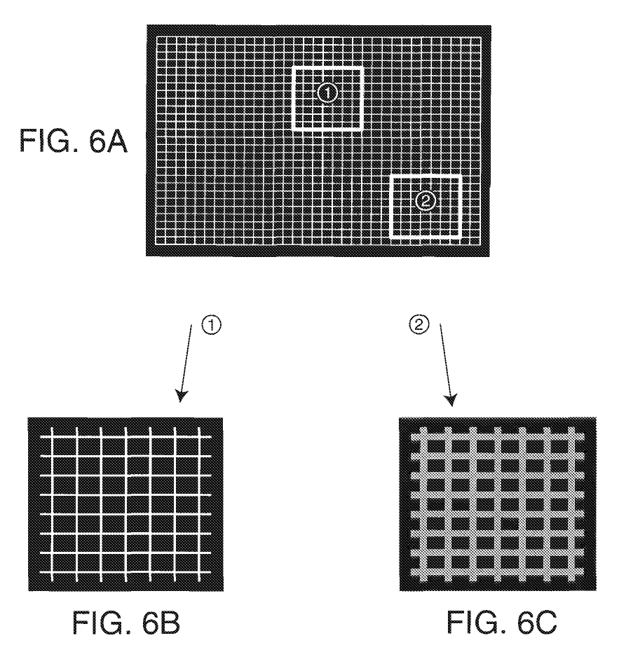

Hereinafter, a specific example will be explained. In such a projector 110 as described above, a simulation of incorporating the retardation element 10 shown in FIGS. 1A and 1B in the liquid crystal light valves 25b, 25f for green light is conducted, and the focusing characteristic of the green light is examined. As a result, as shown in the overall view of FIG. 5A, and partial enlarged views of FIGS. 5B and 5C, it appears that the grid of the projected image is sharp throughout the entire screen. On the other hand, if the retardation element 10 is replaced with a comparative example corresponding to the structure in the middle of the process shown in FIG. 2C, as shown in the overall view of FIG. 6A, and partial enlarged views of FIGS. 6B and 6C, it appears that the grid of the projected image becomes unclear in the periphery of the screen.

### Third Embodiment

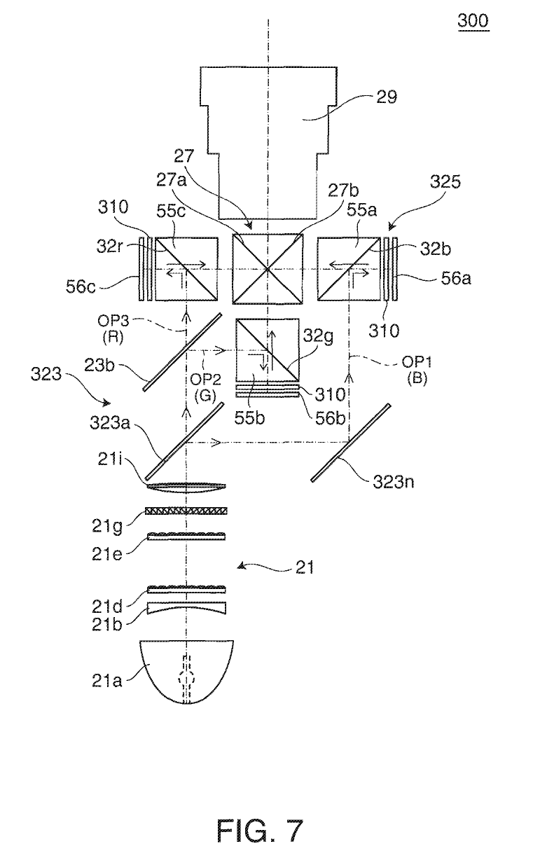

FIG. 7 is a diagram for explaining the configuration of an optical system of a projector incorporating the retardation element 10 shown in FIGS. 1A and 1B. It should be noted that the projector 300 of the third embodiment is a modification of the projector 110 according to the second embodiment, and accordingly the same as the case with the second embodiment unless otherwise explained.

The present projector 300 is provided with a light source device 21 for generating source light, a color separation optical system 323 for dividing the source light from the light source device 21 into three colors of light, red, green! and blue, an optical modulation section 325 illuminated by the illumination light of respective colors emitted from the color separation optical system 323, a cross dichroic prism 27 for combining the image light of respective colors from the optical modulation section 325, and a projection lens 29 as a projection optical system for projecting the image light passed through the cross dichroic prism 27 on a screen (not shown).

The color separation optical system 323 is provided with first and second dichroic mirrors 323a, 23b, and a reflection mirror 323n. In this color separation optical system 323, the substantially white source light from the light source device 21 enters the dichroic mirror 323a. The blue light reflected by the first dichroic mirror 323a enters the polarizing beam splitter 55a via the reflection mirror 323n while staying as, for example, S-polarized light. Further, the green light transmitted through the first dichroic mirror 323a, and reflected by the second dichroic mirror 23b enters the polarizing beam splitter 55b while staying as, for example, S-polarized light. Further, the red light transmitted through the second dichroic mirror 23b enters the polarizing beam splitter 55c while staying as, for example, S-polarized light.

The optical modulation section 325 is provided with three polarizing beam splitters 55a, 55b, and 55c, three liquid crystal panels 56a, 56b, and 56c, and retardation elements 310. Here, the polarizing beam splitter 55a disposed on the first optical path OP1 for the blue light, and the liquid crystal panel 56a and the retardation element 310 associated with the polarizing beam splitter 55a form a liquid crystal light valve for the blue light for performing the intensity modulation on the blue light out of the illumination light two-dimensionally in accordance with the image information. In the liquid crystal light valve for the blue light, the polarizing beam splitter 55a corresponds to the polarization filters 25e, 25e shown in FIG. 4, the liquid crystal panel 56a corresponds to the liquid crystal panel 25a shown in FIG. 4, and the retardation element 310 corresponds to the retardation element 10 shown in FIG. 4.

In the liquid crystal light valve for the blue light, firstly the polarizing beam splitter 55a performs adjustment through the retardation element 310 between the polarization direction of the light entering the liquid crystal panel 56a and the polarization direction of the light emitted from the liquid crystal panel 56a. A polarization splitting film 32b for separating the blue polarized light is built-in in the polarizing beam splitter 55a. Further, the liquid crystal panel 56a is a reflective liquid crystal panel for changing polarization direction of the incident light for every pixel in accordance with the input signal. The liquid crystal panel 56a has a typical configuration of holding the liquid crystal layer between a pair of substrates, and is provided with an oriented film, a transparent common electrode layer, and so on disposed on the front side substrate, and an oriented film, a reflective pixel electrode, a circuit layer, and so on disposed on the reverse side substrate. Finally, the retardation element 310, similarly to the case with the retardation element 10 shown in FIG. 4, for example, is used for the purpose of fine-adjusting the phase modulation amount that the liquid crystal panel 56a has failed to accurately adjust. Although the retardation element 310 has a structure of holding the retardation plate 14 between the first substrate 11 and the second substrate 12 via the adhesive layers 16, 17, similarly to the retardation element 10 shown in FIGS. 1A and 1B, it is different in the direction of the optical axis in the main part 14a and the thickness of the main part 14a of the retardation plate 14. By disposing such a retardation element 310 adjacent to the liquid crystal panel 56a, efficient and precise control of the optical modulation amount by the liquid crystal light valve for the blue light becomes possible.

In the liquid crystal light valve described above, the polarizing beam splitter 55a reflects the S-polarized light out of the incident light by the polarization splitting film 32b to enter the liquid crystal panel 56a, and emits the P-polarized light transmitted through the polarization splitting film 32b out of the modulated light emitted from the liquid crystal panel 56a by reflection and transmitted through the retardation element 310 towards the side of the cross dichroic prism 27. The polarizing beam splitter 55a can be replaced with another reflective polarization splitting element such as a wire grid polarizer disposed at an angle with the system optical axis of the center of the first optical path OP1.

It should be noted that in the liquid crystal panel 56a and the retardation element 310, different from the case with the liquid crystal panel 25a and the retardation element 10 of the projector 110 shown in FIG. 4, the retardation caused herein thought to be doubled because the light reciprocates. Therefore, in the case in which the fine-tuning of the phase modification amount is performed similarly to the retardation element 10 shown in FIG. 4, for example, the adjustment of reducing the thickness of the retardation element 310 to half the thickness of the retardation element 10 is required.

In the optical modulation section 325, the polarizing beam splitter 55b disposed on the second optical path OP2 for the green light, and the liquid crystal panel 56b and the retardation element 310 associated with the polarizing beam splitter 5b form a liquid crystal light valve for the green light for performing the intensity modulation on the green light out of the illumination light two-dimensionally in accordance with the image information. Here, the polarizing beam splitter 55b, the liquid crystal panel 56b, and the retardation element 310 for the green light respectively have the same structures and functions as those of the polarizing beam splitter 55a, the liquid crystal panel 56a, and the retardation element 310 for the blue light. It should be noted that a polarization splitting film 32g for separating the green polarized light is built-in in the polarizing beam splitter 55b.

In the optical modulation section 325, the polarizing beam splitter 55c disposed on the third optical path OP3 for the red light, and the liquid crystal panel 56c and the retardation element 310 associated with the polarizing beam splitter 55c form a liquid crystal light valve for the red light for performing the intensity modulation on the red light out of the illumination light two-dimensionally in accordance with the image information. Here, the polarizing beam splitter 55c, the liquid crystal panel 56c, and the retardation element 310 for the red light respectively have the same structures and functions as those of the polarizing beam splitter 55a, the liquid crystal panel 56a, and the retardation element 310 for the blue light. It should be noted that a polarization splitting film 32r for separating the red polarized light is built-in in the polarizing beam splitter 55c.

Hereinabove, although the invention is explained along the embodiments, the invention is not limited to the embodiments described above, but can be put into practice in various forms within the scope or the spirit of the invention, and the following modification, for example, is also possible.

Although in the above embodiments, the examples of using quartz or the like as the retardation plate 14 of the retardation element 10 are explained, it is also possible to use other positive uniaxial crystals (e.g., calcite, yttrium vanadate, and rutile) besides quartz. Further, negative uniaxial crystals such as sapphire can also used instead of the positive uniaxial crystals. In the above descriptions, in the case in which the material of the retardation plate 14 is a positive or negative uniaxial crystal having bending strength no greater than 200 MPa, the tendency that the distortion of the main part 14a increases is enhanced. However, by adopting the sandwich structure of the present embodiment described above in which the main part 14a of the retardation plate 14 is held between the first and second substrates 11, 12 via, the adhesive layers 16, 17, generation of the refractive force caused by the distortion of the main part 14a can efficiently be prevented.

Further, in the retardation element 10, the order of the First substrate 11 and the second substrate 12 can be switched if necessary. In other words, it is possible that the first substrate 11 is positioned on the incident side while the second substrate 1 is positioned on the emission side, and it is also possible that the second substrate 12 is positioned on the incident side while the first substrate 11 is positioned on the emission side.

Further, in the retardation element 10, there is no need for forming the first substrate 11 and the second substrate 12 with the same material, but it is possible that, for example, the first substrate 11 is made of a negative uniaxial crystal such as sapphire, while the second substrate 12 is made of an isotropic material such as glass. It should be noted that by forming the first substrate 11 with the negative uniaxial crystal such as sapphire and the retardation plate 14 with the positive uniaxial crystal such as quartz, an optical element combining the negative uniaxial crystal and the positive uniaxial crystal can be obtained.

Further, although in the first embodiment, the pressing rim section 14b is provided surrounding the outer periphery of the retardation plate 14, it is possible to provide the pressing rim section 14b only a part of the periphery of the retardation plate 14, for example, only in two sides opposed to each other.

Further, although in the second embodiment, the retardation element 10 is disposed on the incident side of the liquid crystal panels 25a through 25c, it is also possible to dispose the retardation element 10 on the emission side of the liquid crystal panel 25a through 25c. It should be noted that in the case in which a light collecting microlenses are formed on the incident side of the liquid crystal panel 25a through 25c, since the angle of the light passing through the retardation element 10 and the angle of the light passing through the liquid crystal panels 25a through 25c become the same, thus the retardation element 10 is preferably disposed on the emission side of the liquid crystal panels 25a through 25c.

Further, the retardation element 10 as described above can be incorporated in other places in the projectors 110, 300 (e.g., inside the polarization conversion member 21g, the color separation optical system 23, or the projection lens 29) for the purpose of optical compensation, phase conversion, and so on.

Further, although in the third embodiment described above, an example in which the S-polarized light reflected by the polarization splitting film in the polarizing beam splitter 55a, 55b, and 55c is input to the liquid crystal panel 56a, 56b, and 55c, and the P-polarized light transmitted through the polarization splitting film of the polarizing beam splitter 55a, 55b, and 55c is emitted as the image light is only cited, it is also possible that the P-polarized light transmitted through the polarization splitting film in the polarizing beam splitter 55a, 55b, and 55c is input to the liquid crystal panel 56a, 56b, and 56c, and the S-polarized light reflected by the polarization splitting film of the polarizing beam splitter 55a, 55b, and 55c is emitted as the image light.

Further, although in the projectors 110, 300 of the embodiment described above, the light source device 21 is composed of the light source lamp 21a, the pair of fly-eye lenses 21d, 21e, the polarization conversion member 21g, and the superposing lens 21i, the fly-eve lenses 21d, 21e and the polarization conversion member 21g and so on can be eliminated, and the light source lamp 21a can be replaced with another light source such as an LED.

Further, although in the embodiment described above, the color separation of the illumination light is performed using the color separation optical system 23, 323, and after the modulation of each color is performed in the optical modulation section 25, 325, the combination of the images of the respective colors is performed in the cross dichroic prism 27, it is possible to form an image by a single liquid crystal panel, namely the liquid crystal light valve.

Although in the embodiments described above, only the example of the projectors 110, 300 using three liquid crystal panels 95a through 25c, or 56a through 56c are cited, the invention can be applied to a projector using two liquid crystal panels or a projector using four or more liquid crystal panels.

Although in the embodiment, only an example of he front type of projector for performing projection from the direction in which the screen is observed is cited, the invention can be applied to rear projectors for performing projection from the direction opposite to the direction in which the screen is observed.

The entire disclosure of Japanese Patent Application Nos. 2006-235146, filed Aug. 31, 2006 and 2007-162297, filed Jun. 20, 2007 are expressly incorporated by reference herein.

What is claimed is:

1. An optical element comprising:
a first substrate;
a second substrate;
a retardation plate made of an inorganic material having refractive index anisotropy, and having a thin plate like main part to be disposed between the first substrate and the second substrate, the main part being formed to be thin in comparison with a thickness of the first substrate and a thickness of the second substrate;
a first adhesive layer for filling a gap between the first substrate and the retardation plate; and
a second adhesive layer for filling a gap between the retardation plate and the second substrate.

2. The optical element according to claim 1, wherein
a refractive index of the first adhesive layer and a refractive index of the second adhesive layer are substantially the same.

3. The optical element according to claim 2, wherein
a refractive index of the retardation plates the refractive index of the first adhesive layer, and the refractive index of the second adhesive layer are substantially the same.

4. The optical element according to claim 1, wherein
the thin plate like main part of the retardation plate provides retardation, and the retardation plate have a thicker portion having a thickness larger than the main part in at least a part of a surrounding area of the main part.

5. The optical element according to claim 1, wherein
the retardation plate is made of quartz, and the first and the second substrates are made of one of quartz, sapphire, and glass.

6. The optical element according to claim 1, wherein
the first and the second adhesive layers are made of light curing resin.

7. A projector for projecting image light with a projection lens, the image light being formed by an optical modulation device illuminated by an illuminating device, comprising:
the optical element according to claim 1.

8. The projector according to claim 7, wherein
the optical modulation device includes a transmissive liquid crystal panel, and a pair of polarization elements disposed on both sides of the transmissive liquid crystal panel, and
the optical element is disposed between at least one of the polarization elements and the transmissive liquid crystal panel.

9. The projector according to claim 7, wherein
the optical modulation device includes a reflective liquid crystal panel, a polarizing beam splitter provided corresponding to the reflective liquid crystal panel, and the optical element is disposed between the polarizing beam splitter and the reflective liquid crystal panel.

10. The projector according to claim 7, wherein
a refractive index of the first adhesive layer and a refractive index of the second adhesive layer are substantially the same.

11. The projector according to claim 7, wherein
a refractive index of the retardation plate, the refractive index of the first adhesive layer, and the refractive index of the second adhesive layer are substantially the same.

12. The projector according to claim 7, wherein
the thin plate like main part of the retardation plate provides retardation, and the retardation plate have a thicker portion having a thickness larger than the main part in at least a part of a surrounding area of the main part.

13. The projector according to claim 7, wherein
the retardation plate is made of quartz, and the first and the second substrates are made of one of quartz, sapphire, and glass.

14. The projector according to claim 7, wherein
the first and the second adhesive layers are made of light curing resin.

15. A method of manufacturing an optical element, comprising:
forming a retardation plate having a main part with a thickness providing predetermined retardation by etching a planar member made of an inorganic material and having refractive index anisotropy;
pressing a periphery of the retardation plate against a first substrate formed to be thick in comparison with the thickness of the main part of the retardation plate, after the retardation plate is mounted on the first substrate via the first adhesive layer; and
pressing the second substrate against the retardation plate after mounting the second substrate formed to be thick in comparison with the thickness of the main part of the retardation plate via a second adhesive layer.

16. The method of manufacturing an optical element according to claim 15, wherein
the etching of the planar member includes
masking the all of the surfaces of the planar member except a center portion of the one side of the retardation plate, the center portion corresponding to the main part, and
dipping the planar member after masking in an etchant for wet etching.

17. The method of manufacturing an optical element according to claim 15, further comprising:
curing the first adhesive layer with ultraviolet irradiation after pressing the retardation plate against the first substrate via the first adhesive layer; and
curing the second adhesive layer with ultraviolet irradiation after pressing the second substrate against the retardation plate via the second adhesive layer.
